(19) United States
(12) Patent Application Publication
(10) Pub. No.: US 2026/0052107 A1
(43) Pub. Date: Feb. 19, 2026

(54) SYSTEMS AND METHODS FOR INTENT BASED QUALITY OF SERVICE PROVISIONING FOR APPLICATIONS

(71) Applicant: Verizon Patent and Licensing Inc., Basking Ridge, NJ (US)

(72) Inventors: Syed REHMAN, South Brunswick, NJ (US); Raghuram PARVATANENI, Plano, TX (US); Parry Cornell BOOKER, Sunnyvale, TX (US); Sudhakar Reddy PATIL, Flower Mound, TX (US)

(73) Assignee: Verizon Patent and Licensing Inc., Basking Ridge, NJ (US)

(21) Appl. No.: 18/808,436

(22) Filed: Aug. 19, 2024

(51) Int. Cl. H04L 47/2475; H04L 41/5025

(52) U.S. Cl. CPC H04L 47/2475; H04L 41/5025

(57) ABSTRACT

A device may receive one or more quality of service (QoS) characteristics as a QoS intent for an application associated with a network, and may process the QoS intent, real-time network data, and historical network data, with a machine learning model, to predict application-specific QoS requirements. The device may determine a QoS adjustment based on the QoS intent and the QoS requirements, and may cause the network to implement the QoS adjustment.

### BACKGROUND

Within the field of telecommunications, ensuring high-quality service for diverse applications over network infrastructures remains an issue. Application developers are required to specify quality of service (QoS) parameters, such as latency, jitter, and packet loss, to meet performance needs of their applications.

### BRIEF DESCRIPTION OF THE DRAWINGS

FIGS. 1A-1F are diagrams of an example associated with providing intent based QoS provisioning for applications.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for providing intent based QoS provisioning for applications.

### DETAILED DESCRIPTION OF EXAMPLE EMBODIMENTS

The following detailed description of example implementations refers to the accompanying drawings. The same reference numbers in different drawings may identify the same or similar elements.

Current techniques for QoS configuration of applications are largely static and fail to account for the dynamic nature of network conditions and application behavior. This static approach can result in suboptimal application performance, detriments to user experience, and the inability for network services to effectively adapt to evolving circumstances. Conventional network infrastructures often adopt a best effort policy that fails to guarantee fulfillment of QoS characteristics required by applications. This may lead to inconsistent application performance, especially under fluctuating network conditions. Moreover, the application of QoS settings typically does not consider cost implications of employing different network resources nor the subsequent effect of these QoS settings on other network users and services. Thus, current techniques for QoS configuration of applications consume computing resources (e.g., processing resources, memory resources, communication resources, and/or the like), networking resources, and/or other resources associated with handling suboptimal application performance, providing a poor user experience for application users, applications failing to effectively adapt to evolving network circumstances, and/or the like.

Some implementations described herein relate to a provisioning system that provides intent based QoS provisioning for applications. For example, the provisioning system may receive one or more QoS characteristics as a QoS intent for an application associated with a network, and may process the QoS intent, real-time network data, and historical network data, with a machine learning model, to predict application-specific QoS requirements. The provisioning system may determine one of a QoS adjustment, low latency low loss scalable throughput (LAS) provisioning, a slice provisioning, or a dedicated QoS bearer setup based on the QoS intent and the QoS requirements, and may cause the network to implement the one of the QoS adjustment, the LAS provisioning, or the slice provisioning.

In this way, the provisioning system provides intent based QoS provisioning for applications. For example, the provisioning system may provide an integrated solution that not only dynamically and intelligently handles QoS provisioning but also relieves application developers from intricate decisions involved in QoS configurations. Furthermore, the provisioning system may anticipate network conditions and preemptively adjust QoS settings in a way that aligns with defined network policies and user entitlements, ensuring that any adjustments made do not have an adverse impact on the wider network. Thus, the provisioning system may conserve computing resources, networking resources, and/or other resources that would have otherwise been consumed by handling suboptimal application performance, providing a poor user experience for application users, applications failing to effectively adapt to evolving network circumstances, and/or the like.

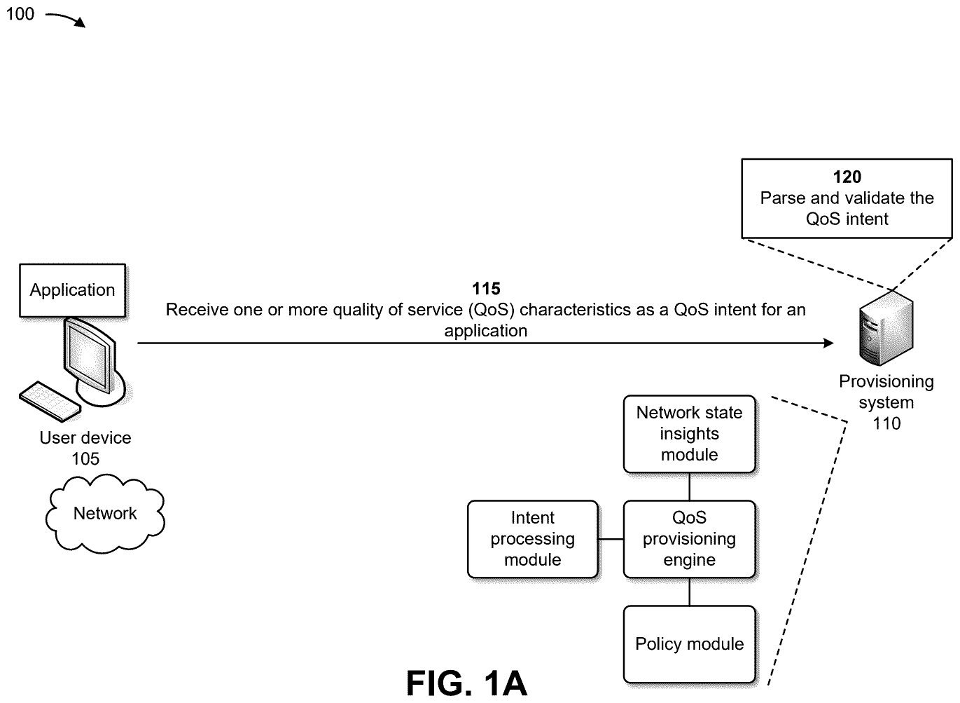

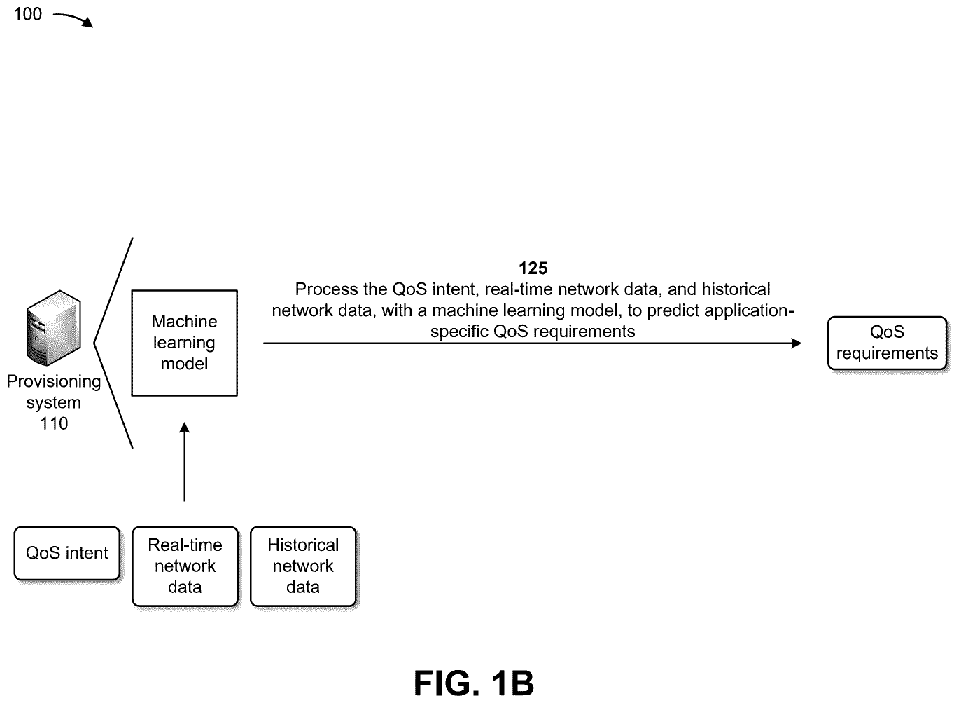

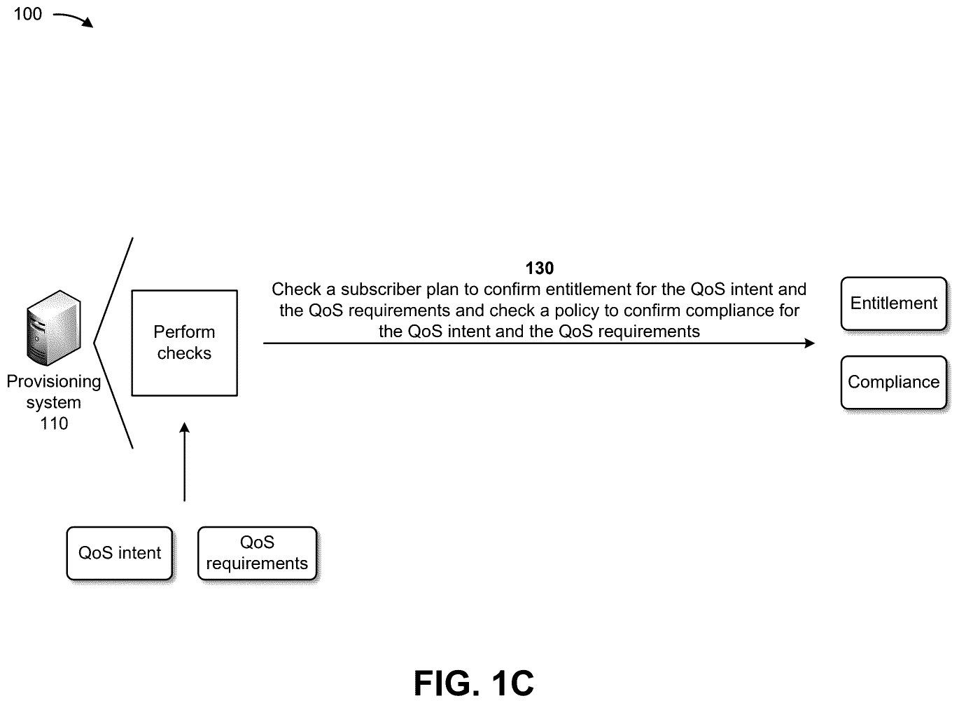

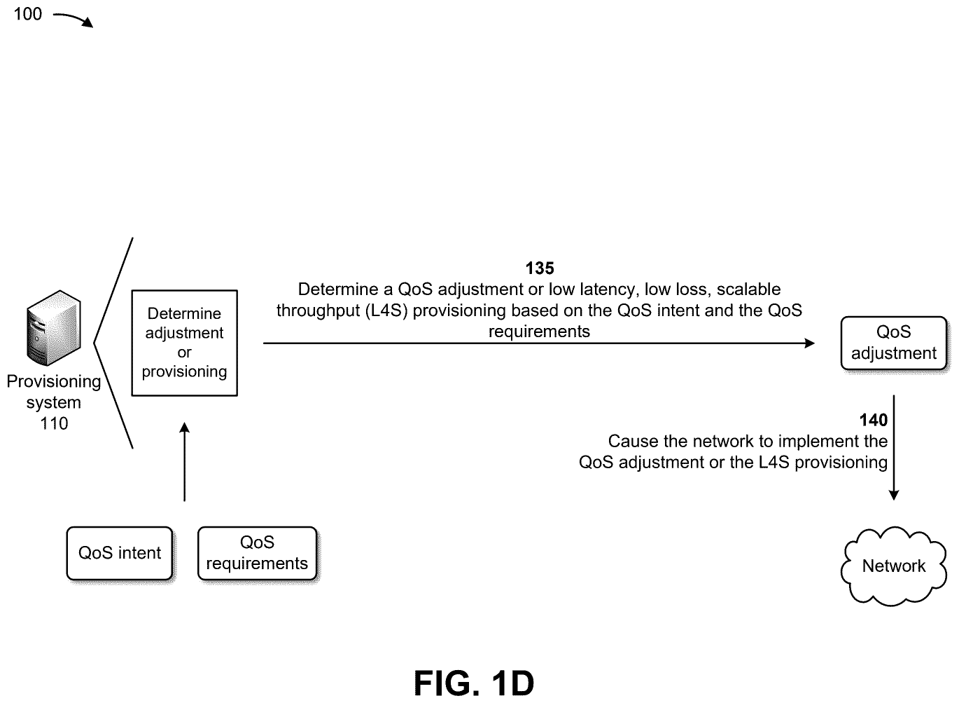

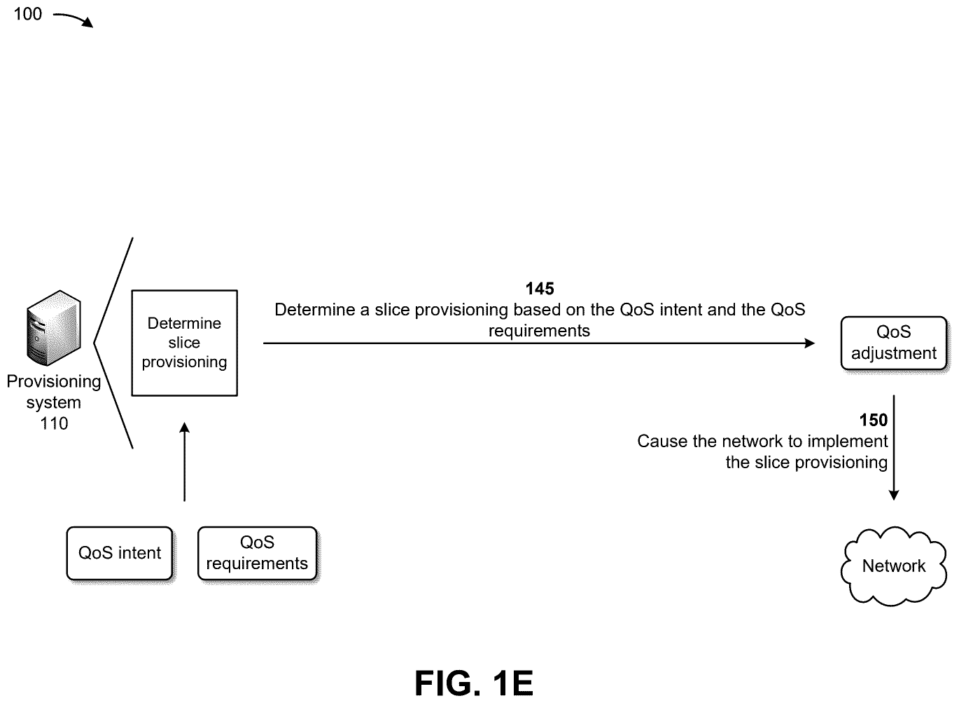

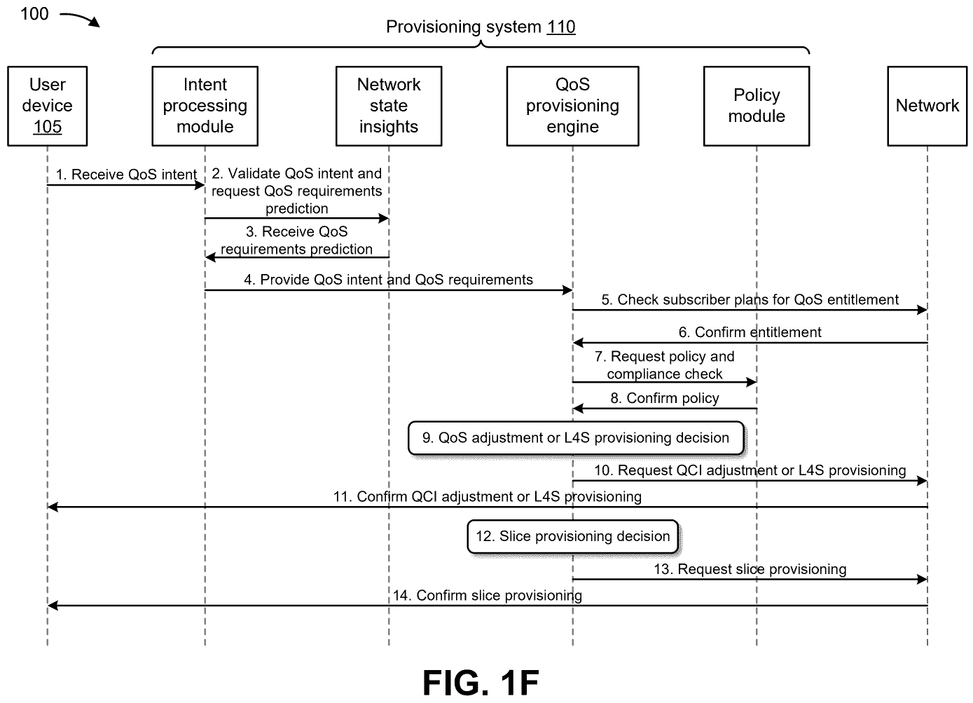

FIGS. 1A-1F are diagrams of an example 100 associated with providing intent based QoS provisioning for applications. As shown in FIGS. 1A-1F, example 100 includes a user device 105 associated with an application, a network, and a provisioning system 110. Further details of the user device 105, the application, the network, and the provisioning system 110 are provided elsewhere herein.

As shown in FIG. 1A, the provisioning system 110 may include an intent processing module, a network state insights module, a QoS provisioning engine, and a policy module. The intent processing module may include an application programming interface (API) for application developers to input desired QoS characteristics (e.g., for applications) as intents. The intent processing module may parse and validate the application developer inputs, and may support various metrics, such as latency, jitter, packet loss, and/or the like. The network state insights module may interface with network probes and sensors to monitor real-time network conditions of the network. The network state insights module may include a machine learning model that utilizes historical network data, real-time network data, and real-time analytics to predict application-specific QoS requirements. The QoS provisioning engine may interface with network control functions to adjust QoS Class Identifier (QCI) values, provision new network slices, apply LAS settings, a dedicated QoS bearer setup, and/or the like. The QoS provisioning engine may utilize models (e.g., if-then models) to dynamically select the optimal adjustments based on current network conditions and application requirements. The QoS provisioning engine may be further be segregated into a QCI provisioning module, a slice provisioning module, and an LAS provisioning module. The policy module may check proposed network adjustments against existing policies, and may maintain LAS, QCI, and slice profiles. The policy module may ensure compatibility and non-interference with other network services and applications.

As further shown in FIG. 1A, and by reference number 115, the provisioning system 110 may receive one or more QoS characteristics as a QoS intent for an application. For example, a user (e.g., an application developer) may utilize the user device 105 to input desired QoS characteristics (e.g., latency, jitter, bandwidth, packet loss, and/or the like) for the application. The QoS characteristics may define preferred operating parameters for a network service of the application. The user may cause the user device 105 to provide the QoS characteristics (e.g., the QoS intent) to the provisioning system 110, and the provisioning system 110 may receive the QoS characteristics from the user device 105.

In some implementations, the provisioning system 110 may receive a variety of QoS characteristics specified for the application, potentially even prioritizing certain QoS characteristics over other QoS characteristics based on requirements of the application. This approach allows for a tailored QoS outline that aligns with the specific needs and preferences of the application, ensuring optimal service delivery. Additionally, or alternatively, the provisioning system 110 may receive, from network sensors, real-time network data, may determine historical network patterns, and may cross-reference the historical network patterns with the QoS intent received from the user device 105.

As further shown in FIG. 1A, and by reference number 120, the provisioning system 110 may parse and validate the QoS intent. For example, the provisioning system 110 may parse the QoS intent by deconstructing the QoS intent into individual QoS characteristics that can be understood by the network. In some implementations, parsing of the QoS intent by provisioning system 110 may include converting high-level QoS intent into specific QoS parameters that can be mapped to network configuration settings such as adjustments. This conversion may translate abstract QoS desires into actionable technical terms, facilitating accurate network service provision.

Validating the QoS intent may ensure that the QoS intent is coherent, actionable, and adheres to the predefined policy limitations and subscription entitlements. Additionally, or alternatively, validating the QoS intent may include confirming the user's QoS request against a catalog of network services and capabilities to ensure compatibility and availability of requested QoS characteristics within the network. The provisioning system 110 may check if requested service levels are consistent with the user's subscription plan and policy constraints of the network, thus ensuring compliance before proceeding with any network adjustments necessary to satisfy the specified QoS characteristics.

As shown in FIG. 1B, and by reference number 125, the provisioning system 110 may process the QoS intent, real-time network data, and historical network data, with a machine learning model, to predict application-specific QoS requirements. For example, the provisioning system 110 may receive the real-time network data from a monitoring system that employs network sensors and/or probes in the network to capture the real-time network data. The real-time network data may include data identifying QoS metrics associated with the network, key performance indicators (KPIs) associated with the network, and/or the like. The historical network data may include real-time network data previously captured by the monitoring system and previously received by the provisioning system 110.

In some implementations, the provisioning system 110 may utilize various machine learning models, such as neural networks, decision trees, support vector machines, and/or the like to predict the application-specific QoS requirements based on the QoS intent, the real-time network data, and the historical network data. These machine learning models offer diverse approaches to analyzing and interpreting data, with neural networks adept at pattern recognition within large datasets, decision trees helpful in breaking down complex decision-making processes, and support vector machines effective at classifying and regression analysis. Depending on the nature of the data and the specific application requirements, one model may be more suitable than another, or a combination of models may be employed for greater accuracy in prediction. Additionally, or alternatively, the provisioning system 110 may utilize statistical analysis, heuristic models, rule-based systems, and/or the like to predict the application-specific QoS requirements based on the QoS intent, the real-time network data, and the historical network data. These methods may provide a different analytical perspective, possibly leading to the identification of correlations or patterns not readily apparent through machine learning alone.

Additionally, or alternatively, the provisioning system 110 may consider alternative sources of data, such as user feedback, third-party service monitoring, or data from similar applications, to enhance the prediction of the application-specific QoS requirements. Incorporating user feedback can provide insights into subjective experiences and expectations, third-party monitoring can offer an external viewpoint on network performance, and similar application data can contribute comparative benchmarks. This breadth of data sources may enrich a predictive capability of the provisioning system 110, supporting a more thorough and nuanced understanding of the application-specific QoS requirements.

Furthermore, the provisioning system 110 may predict the QoS requirements by simulating potential network scenarios and application behaviors using a digital twin model of the network. This alternative approach allows the provisioning system 110 to anticipate and evaluate the impact of various network conditions and application interactions within a virtualized space, closely mirroring the actual network. The digital twin model provides a proactive platform for exhaustive testing and fine-tuning of QoS parameters before deployment. Additionally, or alternatively, the provisioning system 110 may validate the predicted QoS requirements by cross-referencing with predefined QoS profiles for various application types or categories. This validation process may ensure congruity between predicted and established expectations for QoS, benchmarked against recognized standards pertained to similar application types.

As shown in FIG. 1C, and by reference number 130, the provisioning system 110 may check a subscriber plan to confirm entitlement for the QoS intent and the QoS requirements and may check a policy to confirm compliance for the QoS intent and the QoS requirements. For example, the provisioning system 110 may validate the QoS intent and the QoS requirements against subscriber plan data obtained from the network to ensure that subscribers are authorized to receive the requested QoS requirements. This may ensure that only subscribers with appropriate service plans are provided with the requested QoS enhancements, which may include elevated throughput, lower latency, or reduced packet loss.

In some implementations, checking a subscriber plan may include the provisioning system 110 cross-referencing the QoS intent and the QoS requirements with a database of subscription tiers to determine if the QoS intent and the QoS requirements are within the scope of the subscription tiers. This cross-reference may immediately verify whether the QoS intent and the QoS requirements are covered by the subscription tiers, preventing unauthorized access to service level upgrades. Additionally, or alternatively, the provisioning system 110 may utilize a dynamic subscription validation mechanism that updates in real-time based on subscriber plan changes to ensure current eligibility for QoS enhancements. Dynamic validation ensures that a subscriber's entitlement for the QoS intent and the QoS requirements is always up-to-date, accounting for any recent changes like upgrades or downgrades in the service plan.

The provisioning system 110 may also check a policy (e.g., provided by the network) to confirm compliance for the QoS intent and the QoS requirements. The policy review may ensure that the QoS intent and the QoS requirements do not violate any persistent rules or cause unforeseen network congestion or degradation of service for other subscribers. In some implementations, the policy check may include the provisioning system 110 comparing the QoS intent and the QoS requirements against a set of pre-determined QoS parameters and thresholds to prevent network overload or service degradation for existing network traffic. This comparison may maintain an acceptable level of service for all users by ensuring that the QoS intent and the QoS requirements do not detrimentally impact a user experience of other subscribers. Additionally, or alternatively, the provisioning system 110 may utilize a simulation that models potential impacts of the QoS intent and the QoS requirements on the network to determine feasibility before applying changes. This simulation may predict how the QoS intent and the QoS requirements will affect the network, allowing the provisioning system 110 to make informed decisions about whether to proceed with the changes.

Additionally, or alternatively, the policy check may include the provisioning system 110 utilizing a scalability assessment that considers a quantity of subscribers requesting similar QoS adjustments to avoid cumulative negative effects on the network. By assessing the scalability, the provisioning system 110 may ensure that mass requests for enhanced QoS do not compromise overall network integrity and performance. Additionally, for the policy check, the provisioning system 110 may utilize a policy conflict resolution protocol to identify and reconcile conflicts between the QoS intent and the QoS requirements and existing policies, minimizing disruptions.

As shown in FIG. 1D, and by reference number 135, the provisioning system 110 may determine a QoS adjustment or LAS provisioning based on the QoS intent and the QoS requirements. For example, the provisioning system 110 may process the QoS intent and the QoS requirements, with a machine learning model, to determine the QoS adjustment (e.g., one or more QCI adjustments) or the LAS provisioning. In some implementations, the provisioning system 110 may utilize different machine learning models, such as neural networks, decision trees, support vector machines, and/or the like. These different machine learning approaches may offer varying strengths that can be tailored to the specific nuances of the network and application requirements, allowing for more accurate predictions of the QoS adjustment or the LAS provisioning. Additionally, or alternatively, the provisioning system 110 may utilize rule-based models (e.g., if-then rules) to determine the QoS adjustment or the LAS provisioning based on the QoS intent and the QoS requirements. The rule-based models may enable the provisioning system 110 to handle scenarios where predetermined policies or thresholds dictate the QoS adjustment or the LAS provisioning necessary for meeting the QoS intent and the QoS requirements.

Additionally, or alternatively, the provisioning system 110 may utilize heuristic models to prioritize the QoS adjustment or the LAS provisioning based on a cost-effectiveness of the implementation. This may ensure that less resource-intensive solutions are considered initially. Such heuristic models may enable the provisioning system 110 to offer a graduated response to QoS demands, first applying simpler, less costly methods before resorting to more complex and potentially expensive solutions. The provisioning system 110 may then determine an optimal QoS adjustment or LAS provisioning, which may include network configuration adjustments and aims to improve the QoS of the application without reducing the performance of other applications.

As further shown in FIG. 1D, and by reference number 140, the provisioning system 110 may cause the network to implement the QoS adjustment or the LAS provisioning. For example, the provisioning system 110 may instruct a network node (e.g., a network exposure function (NEF) or a service capability exposure function (SCEF)) to implement the QoS adjustment or the LAS provisioning, and the network node may implement the QoS adjustment or the LAS provisioning. In some implementations, the QoS adjustment may include the network reconfiguring existing network slices instead of creating new network slices, as a means to fulfill the QoS intent and the QoS requirements while managing network resources effectively. Reconfiguring existing network slices may provide for a more efficient use of network resources and can be accomplished more swiftly than creating new network slices from scratch.

Additionally, or alternatively, the provisioning system 110 may consider alternative QoS provisioning, such as traffic steering or traffic shaping, which can reroute data flows to alternative paths to meet the QoS intent and expand on the LAS provisioning. These alternative QoS provisionings may enable the network to respond dynamically to varying conditions and demands. Furthermore, the provisioning system 110 may implement a feedback loop using sensors or probes to continually monitor the network performance after the QoS adjustment or the LAS provisioning, ensuring that the QoS requirements are consistently met. The feedback loop may provide real-time data on network performance, allowing for ongoing adjustments and fine-tuning of QoS parameters to ensure sustained compliance with user expectations and application requirements.

As shown in FIG. 1E, and by reference number 145, the provisioning system 110 may determine a slice provisioning based on the QoS intent and the QoS requirements. For example, the provisioning system 110 may process the QoS intent and the QoS requirements, with a machine learning model, to determine the slice provisioning. In some implementations, the provisioning system 110 may utilize different machine learning models, such as neural networks, decision trees, support vector machines, and/or the like. These different machine learning approaches may offer varying strengths that can be tailored to the specific nuances of the network and application requirements, allowing for more accurate predictions of the slice provisioning.

Slice provisioning may include allocating a segmented portion or a slice of the network resources to meet the QoS requirements of specific applications or services. Allocating a slice of network resources is inherently dynamic and considers current network conditions, application demands, as well as policy compliance and subscriber entitlements. Additionally, or alternatively, the provisioning system 110 may determine the slice provisioning by utilizing predictive analytics to anticipate network congestion and pre-emptively adjust QoS settings to prevent degradation of service. Predictive analytics may provide foresight into potential network traffic patterns, thereby enabling proactive measures to maintain service quality.

As further shown in FIG. 1E, and by reference number 150, the provisioning system 110 may cause the network to implement the slice provisioning. For example, the provisioning system 110 may instruct a network node (e.g., an operational support system (OSS), a unified data management (UDM) component, a unified data repository (UDR), and/or the like) to implement the slice provisioning, and the network node may implement the slice provisioning. In some implementations, the provisioning system 110 may interface with the network node to apply determined network slice configurations for the slice provisioning. In some implementations, causing the network to implement the slice provisioning may include the provisioning system 110 causing traffic rerouting to maintain service quality when traditional provisioning methods are insufficient or non-optimal. Traffic rerouting may divert data flows across alternative paths, preserving application performance amidst network disruptions or peak usage periods. Additionally, or alternatively, causing the network to implement the slice provisioning may include the provisioning system 110 checking a subscriber's plan and confirming entitlement and compliance for the QoS intent and QoS requirements before the slice provisioning. By implementing the slice provisioning, the provisioning system 110 may ensure that the network can meet the specified application QoS requirements, thereby enhancing the reliability and performance of the application.

FIG. 1F depicts an example information flow diagram associated with providing intent based QoS provisioning for applications. As shown at step 1 of FIG. 1F, the intent processing module may receive the QoS intent from the user device 105. For example, the intent processing module may receive one or more QoS characteristics as the QoS intent for an application associated with a network. The QoS intent may include data identifying latency, jitter, and packet as requirements for an expected QoS level for the application.

As shown at step 2, the intent processing module may validate the QoS intent and request a QoS requirements prediction from the network state insights module. For example, the intent processing module may validate the QoS intent against data received from the network. This validation may include cross-referencing the QoS intent against a predefined set of network profiles or QoS templates. The network state insights module may receive the request for the QoS requirements prediction, and may process the QoS intent, real-time network data, and historical network data, with a machine learning model, to predict the QoS requirements.

As shown at step 3, the intent processing module may receive the QoS requirements prediction from the network state insights module. For example, the network state insights module may provide the QoS requirements prediction to the intent processing module, and the intent processing module may receive the QoS requirements prediction from the network state insights module. The QoS requirements prediction may offer foresight into potential network congestions or performance issues, enabling preemptive adjustments to maintain desired QoS levels.

As shown at step 4, the intent processing module may provide the QoS intent and the QoS requirements to the QoS provisioning engine. For example, the QoS provisioning engine may receive the QoS intent and the QoS requirements from the intent processing module. The QoS provisioning engine may employ models and policies to dynamically select the best possible QoS adjustments, which may involve a multi-criteria decision-making process that weighs various factors, such as cost, resource availability, and projected network load. As shown at steps 5 and 6, the QoS provisioning engine may check subscriber plans for the QoS entitlement (e.g., for the QoS intent and the QoS requirements) from the network, and the network may confirm the QoS entitlement. For example, beyond checking subscriber plans for QoS entitlement, the QoS provisioning engine may also reference a global QoS catalog that standardizes QoS levels across different networks. The global QoS catalog may enhance an interoperability of QoS provisions and may provide a cohesive experience for applications and users, irrespective of the network.

As shown at step 7, the QoS provisioning engine may request a policy and compliance check from the policy module. For example, the QoS provisioning engine may request a policy and compliance check (e.g., for the QoS intent and the QoS requirements) from the policy module. The policy module may assist in maintaining a legality and ethicality of the QoS intent and the QoS requirements, ensuring that they are in line with current regulations and standards.

As shown at step 8, the QoS provisioning engine may receive confirmation of the policy from the policy module. This confirmation may ensure that the QoS intent and the QoS requirements are not only feasible but also permissible within the regulatory boundaries applicable to the network and services.

As shown at step 9, the QoS provisioning engine may make a QoS adjustment or an LAS provisioning decision based on the QoS intent and the QoS requirements. For example, the QoS provisioning engine may process the QoS intent and the QoS requirements, with a machine learning model, to determine the QoS adjustment (e.g., a QCI adjustment, such as a dedicated QoS setup) or the LAS provisioning decision. The QoS provisioning engine may evaluate a potential impact of the QoS adjustment or the LAS provisioning decision on other services to avoid adverse effects on overall network performance.

As shown at step 10, the QoS provisioning engine may request a QCI adjustment or LAS provisioning from the network. For example, the QoS provisioning engine may cause the network to implement the QCI adjustment or the LAS provisioning. In some implementations, the QoS provisioning engine may instruct a network node to implement the QCI adjustment or the LAS provisioning, and the network node may implement the QCI adjustment or the LAS provisioning.

As shown at step 11, the user device 105 may receive confirmation of the QCI adjustment or the LAS provisioning from the network. For example, once the network implements the QCI adjustment or the LAS provisioning, the network may generate the confirmation of the QCI adjustment or the LAS provisioning, and may provide the confirmation to the user device 105. Upon receiving the confirmation of the QCI adjustment or the LAS provisioning, the user device 105 may display a notification to inform the user of the enhanced QoS status.

As shown at step 12, the QoS provisioning engine may make a slice provisioning decision based on the QoS intent and the QoS requirements. For example, the QoS provisioning engine may process the QoS intent and the QoS requirements, with a machine learning model, to determine the slice provisioning decision. The QoS provisioning engine may also evaluate life cycle management of network slices, considering creation, modification, and decommissioning phases to optimize resource usage.

As shown at step 13, the QoS provisioning engine may request slice provisioning from the network. For example, the QoS provisioning engine may cause the network to implement the slice provisioning. In some implementations, the QoS provisioning engine may instruct a network node to implement the slice provisioning, and the network node may implement the slice provisioning.

As shown at step 14, the user device 105 may receive confirmation of the slice provisioning from the network. For example, once the network implements the slice provisioning, the network may generate the confirmation of the slice provisioning, and may provide the confirmation to the user device 105. Upon receiving the confirmation of the slice provisioning, the user device 105 may display a notification to inform the user of the enhanced QoS status.

In this way, the provisioning system 110 provides intent based QoS provisioning for applications. For example, the provisioning system 110 may provide an integrated solution that not only dynamically and intelligently handles QoS provisioning but also relieves application developers from intricate decisions involved in QoS configurations. Furthermore, the provisioning system 110 may anticipate network conditions and preemptively adjust QoS settings in a way that aligns with defined network policies and user entitlements, ensuring that any adjustments made do not have an adverse impact on the wider network. Thus, the provisioning system 110 may conserve computing resources, networking resources, and/or other resources that would have otherwise been consumed by handling suboptimal application performance, providing a poor user experience for application users, applications failing to effectively adapt to evolving network circumstances, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

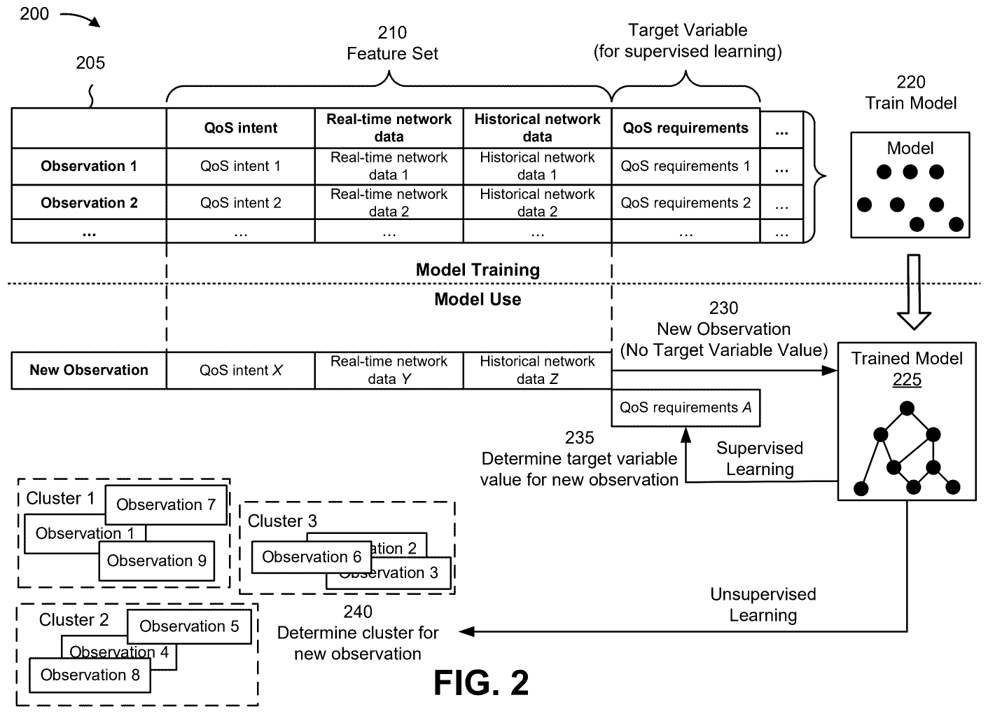

FIG. 2 is a diagram illustrating an example 200 of training and using a machine learning model for predicting QoS requirements for an application. The machine learning model training and usage described herein may be performed using a machine learning system. The machine learning system may include or may be included in a computing device, a server, a cloud computing environment, and/or the like, such as the provisioning system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the provisioning system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the provisioning system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of QoS intent, a second feature of real-time network data, a third feature of historical network data, and so on. As shown, for a first observation, the first feature may have a value of QoS intent 1, the second feature may have a value of real-time network data 1, the third feature may have a value of historical network data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “QoS requirements” and may include a value of QoS requirements 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model. In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of QoS intent X, a second feature of real-time network data Y, a third feature of historical network data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of QoS requirements A for the target variable of the energy consumption drop for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a QoS intent cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a real-time network data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to predict QoS requirements for an application. The machine learning system enables recognition and/or identification of tens, hundreds, thousands, or millions of features and/or feature values for tens, hundreds, thousands, or millions of observations, thereby increasing accuracy and consistency and reducing delay associated with predicting QoS requirements for an application relative to requiring computing resources to be allocated for tens, hundreds, or thousands of operators to manually predict QoS requirements for an application.

As indicated above, FIG. 2 is provided as an example. Other examples may differ from what is described in connection with FIG. 2.

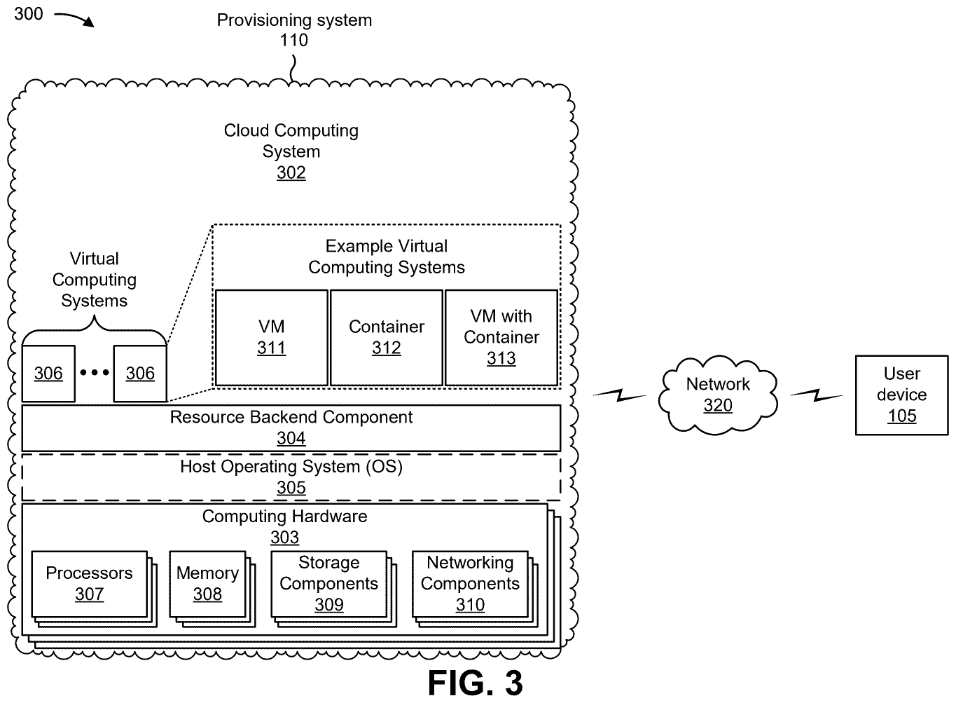

FIG. 3 is a diagram of an example environment 300 in which systems and/or methods described herein may be implemented. As shown in FIG. 3, the environment 300 may include the provisioning system 110, which may include one or more elements of and/or may execute within a cloud computing system 302. The cloud computing system 302 may include one or more elements 303-313, as described in more detail below. As further shown in FIG. 3, the environment 300 may include the user device 105 and/or a network 320. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

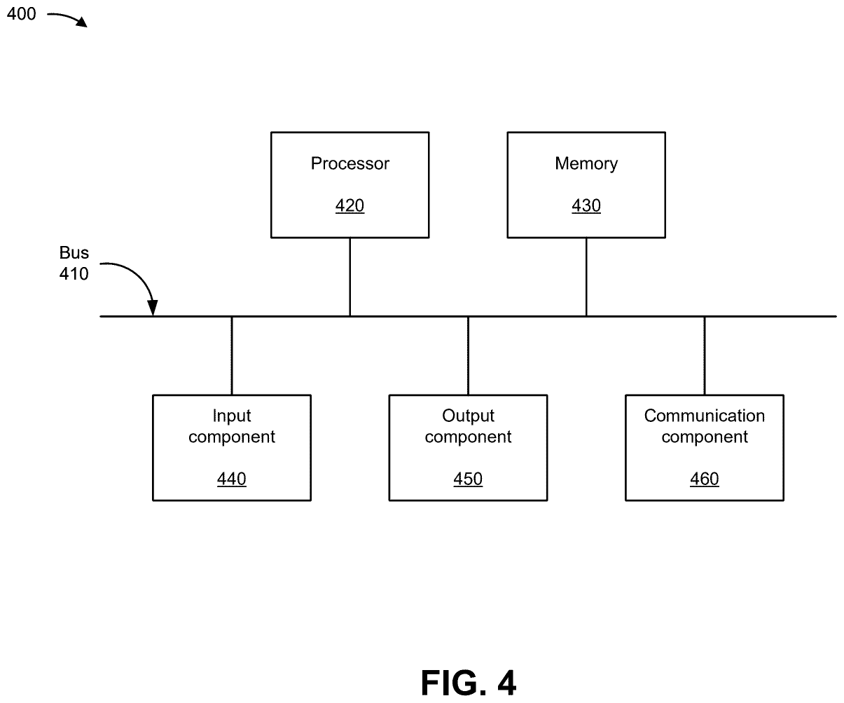

Although the provisioning system 110 may include one or more elements 303-313 of the cloud computing system 302, may execute within the cloud computing system 302, and/or may be hosted within the cloud computing system 302, in some implementations, the provisioning system 110 may not be cloud-based (e.g., may be implemented outside of a cloud computing system) or may be partially cloud-based. For example, the provisioning system 110 may include one or more devices that are not part of the cloud computing system 302, such as the device 400 of FIG. 4, which may include a standalone server or another type of computing device. The provisioning system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105 and/or the provisioning system 110. In some implementations, the user device 105 and/or the provisioning system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

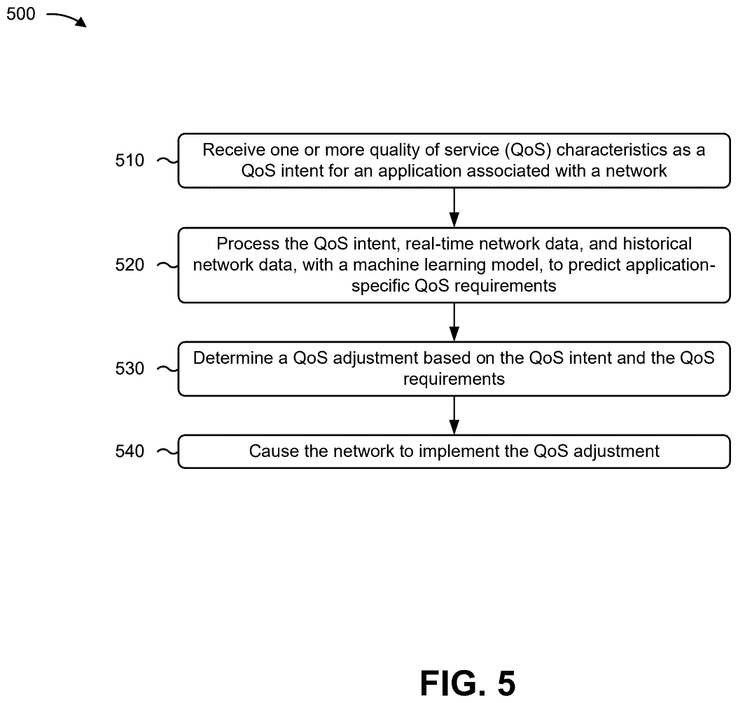

FIG. 5 is a flowchart of an example process 500 for providing intent based QoS provisioning for applications. In some implementations, one or more process blocks of FIG. 5 may be performed by a device (e.g., the provisioning system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving one or more QoS characteristics as a QoS intent for an application associated with a network (block 510). For example, the device may receive one or more QoS characteristics as a QoS intent for an application associated with a network, as described above.

As further shown in FIG. 5, process 500 may include processing the QoS intent, real-time network data, and historical network data, with a machine learning model, to predict application-specific QoS requirements (block 520). For example, the device may process the QoS intent, real-time network data, and historical network data, with a machine learning model, to predict application-specific QoS requirements, as described above.

As further shown in FIG. 5, process 500 may include determining a QoS adjustment based on the QoS intent and the QoS requirements (block 530). For example, the device may determine a QoS adjustment based on the QoS intent and the QoS requirements, as described above. In some implementations, the QoS adjustment is a QoS Class Identifier adjustment.

As further shown in FIG. 5, process 500 may include causing the network to implement the QoS adjustment (block 540). For example, the device may cause the network to implement the QoS adjustment, as described above. In some implementations, the QoS adjustment improves a QoS for the application without reducing a QoS of another application associated with the network. In some implementations, the QoS adjustment improves a QoS of the application relative to a QoS of the application prior to the network implementing the QoS adjustment.

In some implementations, process 500 includes determining LAS provisioning based on the QoS intent and the QoS requirements, and causing the network to implement the LAS provisioning. In some implementations, the LAS provisioning improves a QoS of the application relative to a QoS of the application prior to the network implementing the LAS provisioning.

In some implementations, process 500 includes determining a slice provisioning based on the QoS intent and the QoS requirements, and causing the network to implement the slice provisioning. In some implementations, the slice provisioning improves a QoS of the application relative to a QoS of the application prior to the network implementing the slice provisioning.

In some implementations, process 500 includes parsing and validating the QoS intent prior to processing the QoS intent with the machine learning model. In some implementations, process 500 includes checking a subscriber plan to confirm entitlement for the QoS intent and the QoS requirements, and checking a policy to confirm compliance for the QoS intent and the QoS requirements.

In some implementations, process 500 includes determining one or more network configuration adjustments based on the QoS intent and the QoS requirements, and causing the network to implement the one or more network configuration adjustments. In some implementations, process 500 includes utilizing one or more network sensors to receive the real-time network data from the network. In some implementations, process 500 includes updating a QoS Class Identifier profile based on the QoS adjustment.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, one or more quality of service (QoS) characteristics as a QoS intent for an application associated with a network;
processing, by the device, the QoS intent, real-time network data, and historical network data, with a machine learning model, to predict application-specific QoS requirements;
determining, by the device, a QoS adjustment based on the QoS intent and the QoS requirements; and
causing, by the device, the network to implement the QoS adjustment.

2. The method of claim 1, further comprising:
determining low latency low loss scalable throughput (LAS) provisioning based on the QoS intent and the QoS requirements; and
causing the network to implement the LAS provisioning.

3. The method of claim 2, wherein the LAS provisioning improves a QoS of the application relative to a QoS of the application prior to the network implementing the LAS provisioning.

4. The method of claim 1, further comprising:
determining a slice provisioning based on the QoS intent and the QoS requirements; and
causing the network to implement the slice provisioning.

5. The method of claim 4, wherein the slice provisioning improves a QoS of the application relative to a QoS of the application prior to the network implementing the slice provisioning.

6. The method of claim 1, further comprising:
parsing and validating the QoS intent prior to processing the QoS intent with the machine learning model.

7. The method of claim 1, further comprising:
checking a subscriber plan to confirm entitlement for the QoS intent and the QoS requirements; and
checking a policy to confirm compliance for the QoS intent and the QoS requirements.

8. A device, comprising:
one or more processors configured to:
receive one or more quality of service (QoS) characteristics as a QoS intent for an application associated with a network;
validate the QoS intent based on data received from a network monitoring system;
process the QoS intent, real-time network data, and historical network data, with a machine learning model, to predict application-specific QoS requirements;
determine a QoS adjustment based on the QoS intent and the QoS requirements; and
cause the network to implement the QoS adjustment.

9. The device of claim 8, wherein the QoS adjustment is a QoS Class Identifier adjustment.

10. The device of claim 8, wherein the one or more processors are further configured to:
determine one or more network configuration adjustments based on the QoS intent and the QoS requirements; and
cause the network to implement the one or more network configuration adjustments.

11. The device of claim 8, wherein the QoS adjustment improves a QoS for the application without reducing a QoS of another application associated with the network.

12. The device of claim 8, wherein the one or more processors are further configured to:
utilize one or more network sensors to receive the real-time network data from the network.

13. The device of claim 8, wherein the one or more processors are further configured to:
update a QoS Class Identifier profile based on the QoS adjustment.

14. The device of claim 8, wherein the QoS adjustment improves a QoS of the application relative to a QoS of the application prior to the network implementing the QoS adjustment.

15. A non-transitory computer-readable medium storing a set of instructions, the set of instructions comprising:
one or more instructions that, when executed by one or more processors of a device, cause the device to:
receive one or more quality of service (QoS) characteristics as a QoS intent for an application associated with a network;
process the QoS intent, real-time network data, and historical network data, with a machine learning model, to predict application-specific QoS requirements;
determine a QoS adjustment based on the QoS intent and the QoS requirements; and
cause the network to implement the QoS adjustment,
wherein the QoS adjustment improves a QoS of the application relative to a QoS of the application prior to the network implementing the QoS adjustment.

16. The non-transitory computer-readable medium of claim 15, wherein the one or more instructions further cause the device to:
determine low latency low loss scalable throughput (LAS) provisioning based on the QoS intent and the QoS requirements; and
cause the network to implement the LAS provisioning,
wherein the LAS provisioning improves a QoS of the application relative to a QoS of the application prior to the network implementing the LAS provisioning.

17. The non-transitory computer-readable medium of claim 15, wherein the one or more instructions further cause the device to:
determine a slice provisioning based on the QoS intent and the QoS requirements; and
cause the network to implement the slice provisioning, wherein the slice provisioning improves a QoS of the application relative to a QoS of the application prior to the network implementing the slice provisioning.

18. The non-transitory computer-readable medium of claim 15, wherein the one or more instructions further cause the device to:
check a subscriber plan to confirm entitlement for the QoS intent and the QoS requirements; and
check a policy to confirm compliance for the QoS intent and the QoS requirements.

19. The non-transitory computer-readable medium of claim 15, wherein the one or more instructions further cause the device to:
determine one or more network configuration adjustments based on the QoS intent and the QoS requirements; and
cause the network to implement the one or more network configuration adjustments.

20. The non-transitory computer-readable medium of claim 15, wherein the one or more instructions further cause the device to:
utilize one or more network sensors to receive the real-time network data from the network.
